(19) United States
(12) Patent Application Publication
(10) Pub. No.: US 2024/0387844 A1
(43) Pub. Date: Nov. 21, 2024

(54) METHOD FOR OPERATING A FUEL CELL FACILITY

(71) Applicant: CELLCENTRIC GMBH & CO. KG, Kirchheim (DE)

(72) Inventors: Thomas BAUR, Kirchheim/Teck-Nabern (DE); Sven SCHMALZRIEDT, Kirchheim/Teck-Nabern (DE); Alexander MATHEIS, Kirchheim/Teck-Nabern (DE); Fabian LEUPOLZ, Kirchheim/Teck-Nabern (DE)

(21) Appl. No.: 18/578,818

(22) PCT Filed: Aug. 5, 2022
(86) PCT No.: PCT/EP2022/072042

§ 371 Date: Jan. 12, 2024

(30) Foreign Application Priority Data
Aug. 6, 2021 (DE) 10 2021 208 597.0

(51) Int. Cl. H01M 8/04664; H01M 8/0438; H01M 8/04746

(52) U.S. Cl. CPC H01M 8/04679; H01M 8/04388; H01M 8/04753; H01M 8/04783; H01M 2250/20

(57) ABSTRACT

The invention relates to a method for operating a fuel cell facility with at least one fuel cell system, which is supplied with hydrogen on the anode side from a hydrogen source via a system shut-off valve. According to the invention, at least one operating parameter of each fuel cell system is detected in order to determine whether it is operating or not, wherein in the case of non-operation
a) the pressure in a line between the system shut-off valve and a pressure control and metering valve is reduced; and/or
b) at least one anode-side pressure sensor of the respective fuel cell system remains active for monitoring the anode side of this fuel cell system, wherein an error signal is triggered in the event of a deviation of the detected pressure value(s).

The invention relates to a method for operating a fuel cell facility with at least one fuel cell system of the type defined in more detail in the preamble of claim 1. The invention also relates to a fuel cell facility per se as well as to a vehicle with such a fuel cell facility.

Especially when used in vehicles in which fuel cell facilities with one or more fuel cell systems provide at least part of the electrical drive power, these fuel cell facilities are susceptible to various unfavorable external disturbances that occur while driving, such as vibrations, shocks, if the vehicle hits a pothole or drives on a curb or the like. Fuel cell systems in vehicles are not constantly in operation, or in the case of a fuel cell facility with several fuel cell systems, not all of them are always in operation. For example, the vehicle may have a system in which electrical drive power is provided via a battery so that the fuel cell facility is not operated. In the case of a fuel cell facility with multiple fuel cell systems, depending on the performance requirements of the vehicle on the fuel cell facility, not all fuel cell systems may be operated at the same time.

In such non-operated fuel cell systems, while a vehicle is driving, of a fuel cell facility with at least one such fuel cell system, it is now the case that due to vibrations or in particular shocks, for example due to an uneven road, driving off-road, a pothole or the like, various valves in the non-operated fuel cell system can be incorrectly opened for a short time due to dynamic acceleration forces. The cause for this lies the valve body, which typically has a mass, which is lifted from the valve seat due to the moment of inertia in the event of a shock or vibration and, accordingly, a resulting acceleration, so that, for example, hydrogen can flow from a hydrogen source into or out of the fuel cell system. If this is not operated, the incoming hydrogen cannot be converted, which can lead to undesirable hydrogen emissions, for example. An uncontrolled increase in pressure, for example on the anode side of a fuel cell system, can also be critical, since an undesirably high pressure difference to the cathode side can occur across the individual cells, which, especially when the fuel cell is designed as a PEM fuel cell, can lead to damage to membranes, bipolar plates or the like.

The object of the present invention is to provide a method for operating a fuel cell facility with at least one fuel cell system according to the type defined in more detail in the preamble of claim 1, in which safe operation is possible even in the critical situations mentioned.

According to the invention, this object is achieved by a method for operating a fuel cell facility having the features in claim 1. Advantageous embodiments and developments result from the corresponding dependent claims. An alternative solution to the above-mentioned objective based on a fundamentally comparable method is also specified in claim 4. Advantageous embodiments and developments result from the corresponding dependent claims.

A fuel cell facility suitable for carrying out the method is specified in claim 12. Here too, an advantageous development results from the dependent claim. Claim 14 finally specifies a vehicle with such a fuel cell facility. The fuel cell facility and the vehicle also indirectly solve the problem.

The method according to the invention according to the first solution variant provides that at least one operating parameter of each fuel cell system of the fuel cell facility is detected in order to determine whether the respective fuel cell system is in operation or not in operation. In the event that the fuel cell system is not operating, the pressure in a line between the system shut-off valve and the pressure control and metering valve of the respective fuel cell system is then reduced.

Typically, the pressure present before the system shut-off valve is either the pressure of the hydrogen source or the pressure that has already been adjusted via a first pressure regulator, depending on the design of the hydrogen source, for example as a compressed gas storage, a storage for liquid hydrogen or the like. The system shut-off valve closes off this region, wherein in this case, according to a particularly favorable development of the idea, a normally closed system shut-off valve is used, in which the applied pressure on the side facing away from the line presses a valve body into a valve seat when the system shut-off valve is deactivated. In this preferred development according to the invention, the system shut-off valve is designed in such a way that the higher pressure supports the closing of the system shut-off valve. In the region of the line that connects to the system shut-off valve, there is then a rather lower pressure level, which is then reduced to the low pressure for the respective fuel cell system via a pressure control and metering valve. If the pressures in the region before and after the system shut-off valve are relatively close together, then even simple vibrations can cause the valve body of the system shut-off valve to accidentally lift off, so that hydrogen flows into this region and a higher pressure sets in than is actually desired and expected in a non operating fuel cell system. This can lead to corresponding problems if the pressure control and metering valve is also opened at the same time or at a later time.

The solution according to the invention now provides that the pressure in this line, i.e. in the region between the system shut-off valve and the pressure control and metering valve, is reduced accordingly.

According to a very advantageous development of the idea, the pressure in the line is reduced to a pressure level below the pressure level on the side of the system shut-off valve facing away from the line. Such a reduction in the pressure in the region of the line, which can also be designed as a partial volume in a connection block or the like, helps at improving the function of the system shut-off valve, especially in the preferred embodiment, in which the pressure from the region lying in front of the valve body in the flow direction presses it into the valve seat. The higher the pressure difference across the system shut-off valve, the safer it remains reliably closed even in critical situations, for example when a pothole can no longer be avoided or the like, and can thus safely protect the fuel cell system that is not in operation from an unwanted increase in pressure.

The alternative solution for the method according to the invention also provides that the fuel cell facility has at least one fuel cell system with a hydrogen source and a system shut-off valve, wherein at least one operating parameter is monitored here too in order to detect whether the respective fuel cell system is operating or not. In this solution, at least an anode-side pressure sensor of the respective fuel cell system, which is typically present anyway, is kept active for monitoring the anode side of this fuel cell system or is woken up if necessary, in order to be able to reliably monitor the anode side for pressure changes even when the respective fuel cell system is not in operation. The solution according to the invention then provides that an error signal is triggered in the event of a deviation of the detected pressure values from a specified range. This error signal can then be reacted to accordingly, for example by adjusting the pressure or, in extreme cases, even by an emergency shutdown of the fuel cell system, the entire fuel cell facility, a shutdown warning to a user or similar.

According to a very advantageous development of this variant of the solution according to the invention, it can be provided that in the event of an error signal, medium is replenished and/or drained via anode-side valves in order to adjust the pressure value. For example, the pressure could be adjusted downwards via a purge and/or drain valve or, if necessary, the pressure could be adjusted upwards by a further voluntary opening of the system shut-off valve and/or of a pressure control and metering valve interposed between it and the fuel cell system.

According to a very advantageous embodiment, the monitored anode side can include an anode space of the fuel cell system and an anode recirculation circuit around this anode space.

According to the method, preferably in this monitored anode system, the anode pressure can be adjusted in such a way that the anode pressure is greater than a cathode-side pressure, wherein a pressure difference between anode pressure and cathode-side pressure is less than or equal to 80 kPa (0.8 bar). This makes it possible to efficiently regulate the pressure in order to efficiently protect the structure of the fuel cell itself and to compensate for inflowing medium, which increases the pressure, or outflowing medium, which undesirably reduces the pressure.

According to a further very advantageous embodiment of the method according to the invention, the monitored anode side can further comprise a line between the system shut-off valve and a pressure control and metering valve. This line is the line the pressure of which is reduced according to the first solution of the method according to the invention. This can also be permanently monitored with regard to its pressure value in the second method using a pressure sensor that is typically present anyway, so that pressure changes in this region, which could spread into the respective fuel cell itself, for example in the event of an unintentional opening of the pressure control and metering valve, are already detected, and that here too, an undesirable change in pressure can be counteracted accordingly in order to be able to react more quickly and efficiently in the event of this pressure change being passed on to the region of the fuel cell itself or to reduce the pressure slowly and in a targeted manner instead of risking a sudden transfer.

In particular, in the event of a pressure increase above a predetermined limit, hydrogen can be metered into the anode side in order to reduce this pressure increase. If, for example, when using a cryogenic storage device for liquid hydrogen as a hydrogen source, this increase in pressure comes from the so-called boil-off gas, then according to an advantageous development of this idea, after the hydrogen has been metered into the anode side, the fuel cell can be electrically loaded with the metered hydrogen in order to reduce hydrogen accordingly and thus provide electrical power, which can be temporarily stored in a battery, for example, in order to prevent hydrogen emissions into the environment or to make ideal use of the existing hydrogen.

As long as the amount of hydrogen and the pressure do not become too high, it can also be advantageous to simply meter this hydrogen into the anode side according to the variant described, without electrically loading the fuel cell of the fuel cell system. This means that the hydrogen atmosphere on the anode side is enriched with hydrogen, which means that hydrogen is present on the anode side for as long as possible. This has corresponding advantages with regard to the service life of the fuel cell system when it is restarted, since starting with oxygen or air on both the anode side and the cathode side, a so-called air/air start, leads to significant disadvantages. This is due to the fact that in this case the air on the anode side is flushed out by hydrogen. This means that an air/hydrogen front runs through the anode side of the fuel cell, which can lead to oxidation of the catalyst, which depletes it and thus shortens the life of the fuel cell. If the duration of the hydrogen atmosphere in the anode region can be increased using hydrogen that is already present—in this context, this is referred to as the hydrogen protection time—then this is a significant advantage for the fuel cell.

A fuel cell facility now provides at least one fuel cell system which is set up to carry out a method in one of the ways described. This means that this fuel cell system has the appropriate sensors and/or options for changing the pressures, for example via valves.

According to an extremely favorable development of the fuel cell system, the hydrogen source is designed as a tank for liquid hydrogen.

A vehicle with such a fuel cell system can now use it to generate electrical drive power. Even in adverse conditions while driving the vehicle, for example in the event of strong shocks while driving, driving on very uneven ground or the like, the fuel cell system can be operated safely and without undesirable pressure fluctuations and/or emissions using the two solution variants of the method according to the invention and their embodiments. Further advantageous embodiments of the method, the fuel cell facility and the fuel cell vehicle, which in particular can be a commercial vehicle but not necessarily, also result from the exemplary embodiment, which is described in more detail below with reference to the FIGURE.

The only attached FIGURE shows a fuel cell facility, provided for explaining the method according to the invention.

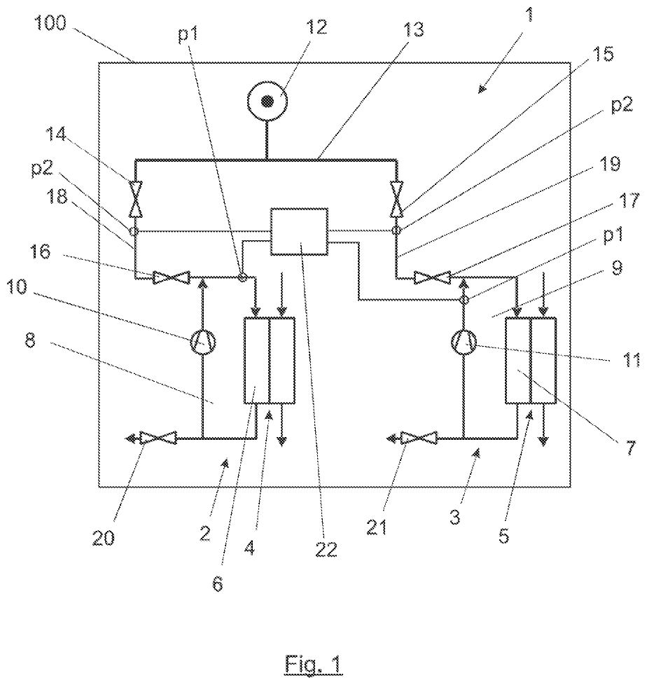

A fuel cell facility 1 is shown in the illustration in FIG. 1. It includes two fuel cell systems 2, 3, one fuel cell stack 4, 5 of which is respectively shown. Only a part of the anode side of the respective fuel cell system 2, 3 is detailed; the further structure of the respective fuel cell system, in particular with regard to the cathode side, the cooling, the electrical circuitry and the like, corresponds to the structures known from the prior art.

The anode side of the respective fuel cell system 2, 3 now includes a respective anode space 6, 7 of the respective fuel cell stack 4, 5 and an anode circuit 8, 9, each with a recirculation conveyor 10, 11, which is shown here purely as an example as a recirculation blower 10, 11. Alternatively or in addition to such a blower, one or more gas jet pumps would also be conceivable.

The respective fuel cell system 2, 3 is supplied, for example, from a common hydrogen source 12, which can be designed, for example, as a compressed gas storage or as a storage for cryogenic hydrogen. This hydrogen source 12 as a compressed gas storage or cryogenic storage is connected to the respective fuel cell system 2, 3 via a supply line 13. Part of the respective fuel cell system 2, 3 is a system shut-off valve 14, 15 and at least one pressure control and metering valve 16, 17, which are each connected to one another via a line 18, 19. It would also be conceivable here for each of the fuel cell systems 2, 3 to have several pressure control and metering valves with parallel flow.

If water and inert gas accumulates in the anode circuit 8, 9 over time, then this is drained into the environment in a known and usual manner, for example from a water separator (not shown here), via a drain and purge valve 20, 21, wherein the environment can in particular also be the exhaust air from the cathode side of the respective fuel cell system 2, 3. The purge and drain valve 20, 21 can in principle also be divided, i.e. into its own purge valve and its own drain valve for each of the fuel cell systems 2, 3.

If at least one of the two fuel cell systems 2, 3 is not operated while driving a vehicle 100 equipped with the fuel cell system 1, which is only indicated here, for example because the power from one of the fuel cell systems 2, 3 is sufficient or because the drive is purely battery-electric and both fuel cell systems 2, 3 are in a stop mode, then vibrations, but in particular dynamic acceleration forces, which occur, for example, when driving over a pothole, when driving over a curb or the like, can cause the system shut-off valve 14, 15 of the affected fuel cell system 2, 3 to open briefly. The same applies to the respective pressure control and metering valve 16, 17 and the purge and drain valve 20, 21. In all cases, this can lead to an undesirable situation in the fuel cell system 2, 3, which may represent a fault, that must be actively counteracted in order to avoid a safety problem, a lifespan problem or unwanted emissions. Furthermore, the fault may cause problems when the respective fuel cell system is restarted later.

In order to avoid such a situation, which can occur due to excessive dynamic acceleration forces and which then often originates from the system shut-off valve 14, 15, in a first variant of a solution approach, the pressure in the region of the line 18, 19 of the currently not operated fuel cell system 2, 3 can be lowered. Typically, the system shut-off valve 14, 15 is designed as a normally closed valve, which is kept closed, for example, by a spring or by the pressure of the hydrogen in the supply line 13. If the inertia of the valve body causes the closed system shut-off valve 14, 15 of the currently non-operated fuel cell system 2, 3 to open briefly, then despite this normally closed characteristic of the system shut-off valve 14, 15, hydrogen can get into the line 18, 19 and from there, possibly, in the event of a further impact or when restarting the fuel cell system 2, 3, undesirably reach the region of the anode side of the respective fuel cell system 2, 3. By lowering the pressure in the lines 18, 19 of the relevant fuel cell system 2, 3, the pressure difference across the valve body of the respective system shut-off valve 14, 15 can be increased when the fuel cell system is not in operation, so that the forces required for lifting the valve body from its valve seat are increased accordingly. This significantly reduces the risk of the system shut-off valve 14, 15 being accidentally opened, for example when driving through a pothole or the like.

Alternatively or in particular in addition to this, in the event that the respective fuel cell system 2, 3 is not operated, pressure monitoring in the region of the anode side of the fuel cell system 2, 3 can also be maintained for the non-operation of this fuel cell system. For this purpose, corresponding pressure sensors p1, which are typically present in the system anyway, and their evaluation electronics 22 are kept awake. The anode side includes at least the anode space 6, 7 of the respective fuel cell 4, 5 as well as the anode recirculation circuit 8, 9 and the volume enclosed therein. It can also monitor the line 18, 19, but in this case it would require the inclusion of a second pressure sensor p2—typically also present anyway—which must be kept awake and evaluated accordingly.

If one of these pressure sensors p1, p2 in the non-operated fuel cell system 2, 3 determines that the pressure changes compared to a specified range, for example by increasing too much or falling too much, then it must be assumed that a valve has been opened accidentally. This can involve the system shut-off valve 14, the pressure control and metering valve 16 or the purge and drain valve 20 accordingly.

If such a fault is detected, an error signal FS is generated, which can then be responded to accordingly. This can be done, for example, if a shock-related opening of the purge and drain valve 20, 21 results in an outflow of hydrogen and thus a reduction in pressure, that this hydrogen is replenished via an intentional opening of the pressure control and metering valve 16, or if necessary, i.e. if there is no longer enough hydrogen in the line 18, 19, by opening the system shut-off valve 14, 15 for a short time. If, on the other hand, there is an increase in pressure, for example because the pressure control and metering valve 16, 17 has opened undesirably, then the purge and drain valve 20, 21 can be intentionally opened to compensate for the pressure in order to reduce the pressure again. This makes it possible to keep the pressure in the desired range simply and efficiently by keeping the pressure monitoring active and responding accordingly to a possible error signal FS, in particular at a pressure level that is determined depending on the pressure on the cathode side of the respective fuel cell 4, 5.

In addition, based on such pressure monitoring, the pressure in the anode space 6, 7 and the anode recirculation 8, 9 can also be increased accordingly, for example by briefly opening the pressure control and metering valve 16, 17. This then leads to a corresponding increase in pressure, but can relieve the pressure level in the respective line 18, 19. Overall, this can mean that the hydrogen loss through possible leaks from the region of these lines can be reduced accordingly and can lead to an extension of the length of time during which the anode side is within a hydrogen atmosphere, which in case of a restart has a positive effect on the lifespan of the respective fuel cell 4, 5.

In particular, if a cryogenic storage is used as a hydrogen source 12, then it can also happen that boil-off gases from this cryogenic storage are present and the pressure increases as a result. Such gases can also be directed to the anode side of the respective fuel cell system 2, 3. They can increase the hydrogen pressure there and, for example, help extend the period of time during which the hydrogen atmosphere is maintained. Alternatively, electrical operation of the respective fuel cell 4, 5 would also be conceivable in such a situation in order to prevent hydrogen emissions, in particular from boil-off gases, and to convert the energy content of these gases accordingly in the fuel cell 4, 5 of the respective fuel cell system 2, 3. The resulting power could then be temporarily stored in a battery. Since the amount of hydrogen is typically very small, it is certainly possible to dispense with an active air supply to the cathode side of the respective fuel cell 4, 5, so that the air flowing in through convection is sufficient to convert the introduced hydrogen or, alternatively, air can be provided via a small blower or a small fan specifically for this case.

What is claimed is:

1. A method for operating a fuel cell facility with at least one fuel cell system, which is supplied with hydrogen from a hydrogen source via a system shut-off valve and a pressure control and metering valve downstream thereto in the flow direction on the anode side,
characterized in that
at least one operating parameter of each fuel cell system is detected in order to determine operation or non-operation of the same, wherein, in the case of non-operation, while the fuel cell facility is otherwise operating, the pressure in a line between the system shut-off valve and the pressure control and metering valve is reduced.

2. The method according to claim 1,
wherein
the pressure in the line is reduced to a pressure level below the pressure level on the side of the system shut-off valve facing away from the line.

3. The method according to claim 1,
wherein
a normally closed valve is used as the system shut-off valve, in which the pressure applied on the side of the system shut-off valve facing away from the line presses the valve body thereof on a valve seat when the system shut-off valve is deactivated.

4. A method for operating a fuel cell system with at least one fuel cell system, which is supplied with hydrogen on the anode side from a hydrogen source via a system shut-off valve,
wherein
at least one operating parameter of each fuel cell system is detected in order to determine operation or non-operation of the same, wherein in the case of non-operation, when the fuel cell facility is otherwise operated, at least one anode-side pressure sensor of the respective fuel cell system remains activated or is activated for monitoring the anode side of this fuel cell system, wherein an error signal is triggered in the event of a deviation of the detected pressure value or values from a predetermined pressure range.

5. The method according to claim 4,
wherein
in the event of an error signal, medium is added and/or drained via anode-side valves in order to adjust the pressure value.

6. The method according to claim 4,
wherein
the monitored anode side comprises an anode space of a fuel stack of the respective fuel cell system and an anode circuit around the anode space.

7. The method according to claim 5,
wherein
the anode pressure is adjusted in such a way that the anode pressure is greater than the pressure on a cathode side of the respective fuel cell system, wherein a pressure difference between the anode side and the cathode side is less than or equal to 80 kPa.

8. The method according to claim 6,
wherein
the monitored anode side further comprises a line between the system shut-off valve and a pressure control and metering valve.

9. The method according to claim 8,
wherein
the pressure in the region of this line is reduced when the respective fuel cell system is not in operation.

10. The method according to claim 8,
wherein
in the event of a pressure increase in the line or in a supply line between the hydrogen source and the system shut-off valve above a predetermined limit value, hydrogen is metered into the line and/or into the anode space.

11. The method according to claim 10,
wherein
the fuel cell stacks of the respective fuel cell system, into the anode space of which hydrogen has been metered, is electrically loaded.

12. A fuel cell facility with at least one fuel cell system, which is configured to carry out a method according to claim 1.

13. The fuel cell facility according to claim 12,
wherein
the fuel cell facility comprises a tank for liquid hydrogen as a hydrogen source.

14. A vehicle with a fuel cell facility according to claim 12, which serves to provide at least part of the electrical drive power.

15. The method according to claim 2, wherein
a normally closed valve is used as the system shut-off valve, in which the pressure applied on the side of the system shut-off valve facing away from the line presses the valve body thereof on a valve seat when the system shut-off valve is deactivated.

16. The method according to claim 5, wherein
the monitored anode side comprises an anode space of a fuel stack of the respective fuel cell system and an anode circuit around the anode space.

17. The method according to claim 6, wherein
the anode pressure is adjusted in such a way that the anode pressure is greater than the pressure on a cathode side of the respective fuel cell system, wherein a pressure difference between the anode side and the cathode side is less than or equal to 80 kPa.

18. The method according to claim 7, wherein
the monitored anode side further comprises a line between the system shut-off valve and a pressure control and metering valve.

19. The method according to claim 9, wherein
in the event of a pressure increase in the line or in a supply line between the hydrogen source and the system shut-off valve above a predetermined limit value, hydrogen is metered into the line and/or into the anode space.

20. A fuel cell facility with at least one fuel cell system, which is configured to carry out a method according to claim 2.
